(19) United States
(12) Patent Application Publication
(10) Pub. No.: US 2013/0230476 A1
(43) Pub. Date: Sep. 5, 2013

(54) Fragrance Compositions Comprising Special Mixtures of Diastereomers of 2-Isobutyl-4-Methyl-Tetrahydro-2H-Pyran-4-OL

(71) Applicants: Ralf Pelzer, Furstenberg (DE); Wolfgang Krause, Bruhl-Rohrhof (DE); Karl Beck, Ostringen (DE); Francis Bocris, Nizza (FR)

(72) Inventors: Ralf Pelzer, Furstenberg (DE); Wolfgang Krause, Bruhl-Rohrhof (DE); Karl Beck, Ostringen (DE); Francis Bocris, Nizza (FR)

(73) Assignee: BASF SE, Ludwigshafen (DE)

(21) Appl. No.: 13/884,503

(22) PCT Filed: Nov. 8, 2011
(86) PCT No.: PCT/EP11/69676

§ 371 Date: May 9, 2013

Related U.S. Application Data
(60) Provisional application No. 61/411,944, filed on Nov. 10, 2010.

(30) Foreign Application Priority Data
Nov. 10, 2010 (EP) 10190693.1

(51) Int. Cl. C11B 9/00

(52) U.S. Cl. CPC C11B 9/008
USPC 424/70.1; 512/11; 510/103; 44/275; 422/123; 514/772; 8/161

(57) ABSTRACT

The present invention relates to a fragrance composition comprising a mixture of diastereomers of 2-isobutyl-4-methyl-tetrahydro-2H-pyran-4-ol, which comprises more than 95 wt. % of the optically inactive cis-racemate and less than 5 wt. % of the optically inactive trans-racemate. The present invention further relates to a method for producing a perfumed product or article as well as perfumed or aromatized articles comprising the fragrance compositions of the present invention.

The present invention relates to a fragrance composition comprising a mixture of diastereomers of 2-isobutyl-4-methyl-tetrahydro-2H-pyran-4-ol, which comprises more than 95 wt. % of the optically inactive cis-racemate and less than 5 wt. % of the optically inactive trans-racemate. The present invention further relates to a method for producing a perfumed product or article as well as perfumed or aromatized articles comprising the fragrance compositions of the present invention.

Lily of the valley- or muguet-type fragrances are widely used and accepted in a large variety of consumer products such as for example detergents of all kind, washing soaps and hygiene and cosmetic products of all kinds. Blends or mixtures of those lily of the valley- or muguet-type fragrances (hereinafter referred to as “fragrance compositions”) often contain the synthetic compound 2-methyl-3-(4-tert.-butylphenyl)propanal of formula (a),

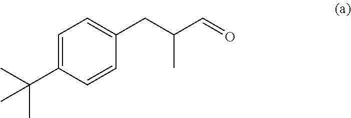

also known under the tradenames Lysmeral® (BASF SE) and Lilestralis® (Innospec Inc.). These products usually also contain the meta-substituted isomer 2-methyl-3-(3-tert.-butylphenyl)propanal (CAS Registry Number 62518-65-4) of formula (b) in an amount of 0.05 wt. % and higher.

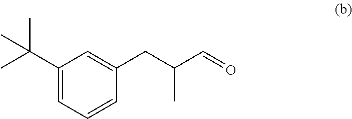

The meta-substituted isomer 2-methyl-3-(3-tert.-butylphenyl)propanal is characterized by a more intense scent than the para-Isomer of formula (a).

Due to more recent results and concerns about the allergenic and toxicologic potential of meta-substituted dihydrocinnamaldehyde derivatives such as, for example, the compound of formula (b), there is a constant need for safe alternatives with fragrance characteristics very similar to those already accepted and expected by the consumer.

EP 0 252 378 discloses aliphatic aldehydes and their use as fragrance ingredients. Specifically, 2,5,7,7-tetramethyloctanal is described as a valuable fragrance ingredient with an intense lily-of-the-valley note. Furthermore, a method for the preparation of the above-mentioned aldehydes is disclosed comprising base catalyzed condensation of the corresponding precursor aldehydes followed by catalytic hydrogenation.

WO 2009/027957 discloses perfumes wherein the compound 2-methyl-3-(4-tert.-butylphenyl)propanal is replaced by other perfume raw materials in accordance with specific mass ratio replacement levels.

The international application PCT/EP2010/056403 discloses a process for the preparation of 2-substituted 4-hydroxy-4-methyltetrahydropyranols by reacting 3-methylbut-3-en-1-ol (isoprenol) with the corresponding aldehydes in the presence of a strongly acidic cation exchanger. Specifically the preparation of 2-isobutyl-4-hydroxy-4-methyltetrahydropyran by reacting isoprenol with isovaleraldehyde is disclosed.

The international application PCT/EP2010/062662 discloses fragrance compositions of the lily of the valley-type comprising 2,5,7,7-tetramethyloctanal (Lyrisal®) and 2-isobutyl-4-methyl-tetrahydro-2H-pyran-4-ol.

It was an object of the present invention to provide suitable fragrances or fragrance compositions with similar, preferable exchangeable fragrance characteristics to those of known lily of the valley- or muguet-type fragrances, especially of meta-substituted dihydrocinnamaldehyde derivatives such as for example the compounds of formula (b). The fragrance compositions should be more efficient and more impactful than known substitutes of the lily of the valley-type fragrance composition. The demanded fragrances or fragrance compositions should also enhance, harmonize and perfect the olfactory and sensory performance of floral compositions.

The fragrances or fragrance compositions should also be readily accessible in technical quantities under economically favorable conditions.

The problem was surprisingly solved by the provision of a fragrance composition comprising
a) a mixture of diastereomers of 2-isobutyl-4-methyl-tetrahydro-2H-pyran-4-ol of formula I

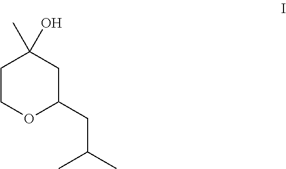

wherein the mixture of diastereomers comprises more than 95 wt. % of the optically inactive cis-racemate of the formulae cis-1H and cis-1H

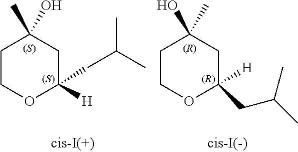

and less than 5 wt. % of the optically inactive trans-racemate of the formulae trans-I(+) and trans-I(−),

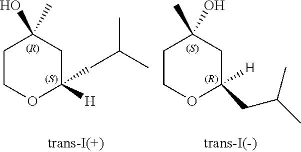

b) optionally one or more additional fragrance substance(s) and c) optionally one or more diluent(s).

It was surprisingly found that the fragrance compositions of the present invention comprising a mixture of diastereomers of 2-isobutyl-4-methyl-tetrahydro-2H-pyran-4-ol of formula I

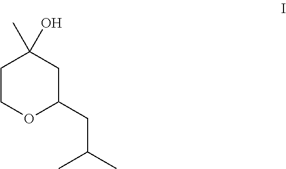

wherein the mixture of diastereomers comprises more than 95 wt. % of the optically inactive cis-racemate of the formulae cis-1H and cis-1H

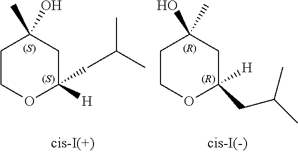

and less than 5 wt. % of the optically inactive trans-racemate of the formulae trans-I(+) and trans-I(−),

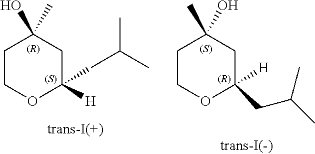

are very well suited as replacements for the established lily of the valley- or muguet-type fragrances of the para- and meta-substituted dihydrocinnamaldehyde type, especially of 2-methyl-3-(4-tert.-butylphenyl)propanal of formula (a) and/or 2-methyl-3-(3-tert.-butylphenyl)propanal of formula (b).

It was furthermore found that the mixture of diastereomers of 2-isobutyl-4-methyl-tetrahydro-2H-pyran-4-ol of formula I comprising more than 95 wt. % of the optically inactive cis-racemate of the formulae cis-1H and cis-1H and less than 5 wt. % of the optically inactive trans-racemate of the formulae trans-I(+) and trans-I(−) results together with other known lily of the valley- or muguet-type fragrances in unexpected synergistic effects. It was surprisingly found that the above mentioned mixture of diastereomers of 2-isobutyl-4-methyl-tetrahydro-2H-pyran-4-ol of formula I is a brilliant new muguet item, adding a sparkling effect in any compound and adding extra value as it enhances and perfects the fragrance characteristics of other known lily of the valley- or muguet-type fragrances so that only minor amount of these known lily of the valley- or muguet-type fragrances are necessary to evoke an odour very similar to that of 2-methyl-3-(3-tert.-butylphenyl)propanal and/or 2-methyl-3-(4-tert.-butylphenyl)propanal. It works in particular on any green floral but also on other types of floral accords.

The fragrance compositions of the present invention comprise usually at least organoleptically active quantities of a mixture of diastereomers of 2-isobutyl-4-methyl-tetrahydro-2H-pyran-4-ol of formula I comprising more than 95 wt. % of the optically inactive cis-racemate of the formulae cis-1H and cis-1H and less than 5 wt. % of the optically inactive trans-racemate of the formulae trans-I(+) and trans-I(−). The fragrance compositions of the present invention can also consist essentially, that means up to 99.9 wt. % based on the total amount of the composition, only of the mixture of diastereomers of 2-isobutyl-4-methyl-tetrahydro-2H-pyran-4-ol of formula I.

Preferably, the fragrance composition of the present invention comprises, based on the total amount of the composition, a total amount of the mixture of diastereomers of 2-isobutyl-4-methyl-tetrahydro-2H-pyran-4-ol of formula I in the range from 0.1 to 98 wt. %, particularly preferably in the range from 0.5 to 96 wt. %, very particularly preferably in the range from 1 to 94 wt. %, in particular in the range from 5 to 90 wt. %.

In a preferred embodiment the fragrance composition of the present invention comprises a mixture of diastereomers of 2-isobutyl-4-methyl-tetrahydro-2H-pyran-4-ol of formula I, which comprises from 95.5 to 99.5 wt. %, particularly preferably from 96 to 99 wt. %, very particularly preferably from 97 to 99 wt. % of the optically inactive cis-racemate of the formulae cis-1H and cis-1H and from 0.5 to 4.5 wt. %, particularly preferably from 1 to 4 wt. %, very particularly preferably from 1 to 3 wt. % of the optically inactive trans-racemate of the formulae trans-I(+) and trans-I(−).

The mixture of diastereomers of 2-isobutyl-4-methyl-tetrahydro-2H-pyran-4-ol of formula I itself consists, based on the total amount of the mixture, of more than 95 wt. %, preferably from 97 to 99.9 wt. %, particularly preferably from 98 to 99.8 wt. % of the optically inactive cis-racemate and the optically inactive trans-racemate.

The mixture of diastereomers of 2-isobutyl-4-methyl-tetrahydro-2H-pyran-4-ol of formula I, which comprises more than 95 wt. % of the optically inactive cis-racemate of the formulae cis-1H and cis-1H and less than 5 wt. % of the optically inactive trans-racemate of the formulae trans-I(+) and trans-I(−) or preferred embodiments of said mixture are called “high-cis Pyranol” in the following description. Mixtures with a certain content of the optically inactive cis-racemate, e.g. 98% of the optically inactive cis-racemate are termed “Pyranol with 98% cis” in the description of the present invention.

“High-cis Pyranol”, which is comprised in the fragrance composition of the present invention, is preferably obtained by distillation and/or rectification starting from mixtures of diastereomers of 2-isobutyl-4-methyl-tetrahydro-2H-pyran-4-ol of formula I, wherein the diastereomer ratio of the cis-diastereomers of the formulae cis-1H and cis-1H to the trans-diastereomer of the formulae trans-I(+) and trans-I(−) is 65:35 to 95:5, preferably 70:30 to 90:10, particularly preferably 75:25 to 85:15.

Mixtures of diastereomers of 2-isobutyl-4-methyl-tetrahydro-2H-pyran-4-ol of formula I with these cis/trans ratios are for example available by the method described in the international application PCT/EP2010/056403.

The fragrance compositions of the present invention may also optionally comprise as component or components b) one or more additional fragrance substance(s). The fragrance compositions of the present invention may also optionally comprise as component or components c) one or more diluent(s). Furthermore, the fragrance compositions of the present invention may also optionally comprise further constituents known to those of skill in the art as common ingredients in fragrance compositions.

Examples of additional fragrance substances b) with which the fragrance compositions of the present invention can be combined advantageously can be found for example in S. Arctander, Perfume and Flavor Materials, Vol. 1 and 11, Montclair, N.J., 1969, self-published, or in K. Bauer, D. Garbe and H. Surburg, Common Fragrance and Flavor Materials, 4th Edition, Wiley-VCH, Weinheim 2001.

The fragrance compositions of the present invention can be combined with one or more individual fragrance substances known to those of skill in the art as additional fragrance substance b) or o as an additional component to be combined or mixed with the finished fragrance composition, comprising but not limited to, for example, fragrances selected from the following groups:

of hydrocarbons, such as, for example, 3-carene; alpha-pinene; beta-pinene; alphaterpinene; gamma-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;
of aliphatic alcohols, such as, for example, hexanol; octanol; 3-octanol; 2,6-dimethylheptanol; 2-methyl-2-heptanol, 2-methyl-2-octanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methylene heptan-2-ol; (E,Z)-2,6-nonadienol; 3,7-dimethyl-7-methoxyoctan-2-ol; 9-decenol; 10-undecenol; 4-methyl-3-decen-5-ol;
of aliphatic aldehydes and acetals thereof, such as, for example, hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethyl acetal; 1,1-dimethoxy-2,2,5-trimethyl-4-hexene; citronellyl oxyacetaldehyde; 1-(1-methoxypropoxy)-(E/Z)-3-hexene; 2,5,7,7-tetramethyloctanal;
of aliphatic ketones and oximes thereof, such as, for example, 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;
of aliphatic sulfur-containing compounds, such as, for example, 3-methylthiohexanol; 3-methylthiohexyl acetate; 3-mercaptohexanol; 3-mercaptohexyl acetate; 3-mercaptohexylbutyrate; 3-acetylthiohexyl acetate; 1-menthene-8-thiol;
of aliphatic nitriles, such as, for example, 2-nonenenitrile; 2-undecenenitrile; 2-tridecenenitrile; 3,12-tridecadienenitrile; 3,7-dimethyl-2,6-octadienenitrile; 3,7-dimethyl-6-octenenitrile; 3,7-dimethyl-octanenitrile;
of esters of aliphatic carboxylic acids, such as, for example, (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl-2-methylpentanoate; ethyl hexanoate; allyl hexanoate; ethyl heptanoate; allyl heptanoate; ethyl octanoate; ethyl-(E,Z)-2,4-decadienoate; methyl-2-octynoate; methyl-2-nonynoate; allyl-2-isoamyloxyacetate; methyl-3,7-dimethyl-2,6-octadienoate; 4-methyl-2-pentyl crotonate;
of acyclic terpene alcohols, such as, for example, citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and formates, acetates, propionates, isobutyrates, butyrates, isovalerates, pentanoates, hexanoates, crotonates, tiglinates and 3-methyl-2-butenoates thereof;
of acyclic terpene aldehydes and ketones, such as, for example, geranial; neral; citronellal; 7-hydroxy-3,7-dimethyloctanal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal;
of cyclic terpene alcohols, such as, for example, menthol; isopulegol; alpha-terpineol; terpinenol-4; menthan-8-ol; menthan-1-01; menthan-7-ol; borneol; isoborneol; linalool oxide; nopol; cedrol; ambrinol; vetiverol; guaiol; and formates, acetates, propionates, isobutyrates, butyrates, isovalerates, pentanoates, hexanoates, crotonates, tiglinates and 3-methyl-2-butenoates thereof;
of cyclic terpene aldehydes and ketones, such as, for example, menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alphadamascone; beta-damascone; beta-damascenone; deltadamascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; 2-methyl-4-(2,6,6-trimethyl-1-cyclohexen-1-yl)-2-butenal; nootkatone; dihydro-nootkatone; 4,6,8-megastigmatrien-3-one; alpha-sinensal; beta-sinensal; acetylated cedarwood oil (methyl cedryl ketone);
of cyclic alcohols, such as, for example, 4-tert-butylcyclohexanol; 3,3,5-trimethylcyclohexanol; 3-isocamphylcyclohexanol; 2,6,9-trimethyl-Z2,Z5,E9-cyclododecatrien-1-ol, 2-isobutyl-4-methyl-tetrahydro-2H-pyran-4-ol; of cycloaliphatic alcohols, such as, for example, alpha-3,3-trimethyl-cyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol; 4-isopropyl-cyclohexylmethanol;
of cyclic and cycloaliphatic ethers, such as, for example, cineol; cedryl methyl ether; cyclododecyl methylether; 1,1-dimethoxycyclododecane; (ethoxymethoxy)cyclododecane; alpha-cedrene epoxide; 3a,6,6,9a-tetramethyldodecahydronaphtho[2,1-b]furan; 3a-ethyl-6,6,9a-trimethyldodecahydronaphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methylpropyl)-1,3-dioxane;
of cyclic and macrocyclic ketones, such as, for example, 4-tert-butylcyclohexanone; 2,2,5-trimethyl-5-pentylcyclopentanone; 2-heptylcyclopentanone; 2-pentylcyclopentan-one; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone;
of cycloaliphatic aldehydes, such as, for example, 2,4-dimethyl-3-cyclohexenecarb-aldehyde; 2-methyl-4-(2,2,6-trimethylcyclohexen-1-yl)-2-butenal; 4-(4-hydroxy-4-methylpentyl)-3-cyclohexenecarbaldehyde; 4-(4-methyl-3-penten-1-yl)-3-cyclohexenecarb-aldehyde;
of cycloaliphatic ketones, such as, for example, 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl-2,6,10-trimethyl-2,5,9-cyclododecatrienyl ketone; tert-butyl-(2,4-dimethyl-3-cyclohexen-1-yl)ketone;
of esters of cyclic alcohols such as, for example, 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentyl-cyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate; 4,7-methano-3a,4,5,6,7,7a-hexahydro-5 or 6-indenyl isobutyrate; 4,7-methanooctahydro-5 or 6-indenyl acetate;
of esters of cycloaliphatic alcohols such as, for example, 1-cyclohexylethyl crotonate;
of esters of cycloaliphatic carboxylic acids, such as, for example, allyl-3-cyclohexyl propionate; allyl cyclohexyloxyacetate; cis- and trans-methyl dihydrojasmonate; cis- and trans-methyl jasmonate; methyl 2-hexyl-3-oxocyclopentanecarboxylate; ethyl-2-ethyl-6,6-dimethyl-2-cyclohexenecarboxylate; ethyl-2,3,6,6-tetramethyl-2-cyclohexenecarboxylate; ethyl-2-methyl-1,3-dioxolane-2-acetate;
of araliphatic alcohols, such as, for example, benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzylalcohol; 1-(4-isopropylphenyl)ethanol;
of esters of araliphatic alcohols and aliphatic carboxylic acids, such as, for example, benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate;
of araliphatic ethers, such as, for example, 2-phenylethyl methyl ether; 2-phenylethyl isoamyl ether; 2-phenylethyl-1-ethoxyethyl ether; phenylacetaldehyde dimethyl acetal; phenylacetaldehyde diethyl acetal; hydratropaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;
of aromatic and araliphatic aldehydes, such as, for example, benzaldehyde; phenylacetaldehyde; 3-phenylpropanal; hydratropaldehyde; 3-(3-Isopropylphenyl)butanal, 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-isobutylphenyl)propanal; 2-methyl-3-(4-tert-butylphenyl)propanal; 3-(4-tert-butylphenyl)propanal; cinnamaldehyde; alpha-butylcinnamaldehyde; alpha-amylcinnamaldehyde; silvial; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-di methoxybenzaldehyde; 2-methyl-3-(4-methoxyphenyl)propanal; 2-methyl-3-(4-methylenedioxyphenyl)propanal;
of aromatic and araliphatic ketones, such as, for example, acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; 2-benzofuranyl ethanone; (3-methyl-2-benzofuranyl)ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;
of aromatic and araliphatic carboxylic acids and esters thereof, such as, for example, benzoic acid; phenylacetic acid; methyl benzoate; ethyl benzoate; hexyl benzoate; benzyl benzoate; methyl phenylacetate; ethyl phenylacetate; geranyl phenylacetate; pheuylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl-2,4-dihydroxy-3,6-dimethylbenzoate; ethyl-3-phenylglycidate; ethyl-3-methyl-3-phenylglycidate;
of nitrogen-containing aromatic compounds, such as, for example, 2,4,6-trinitro-1,3-dimethyl-5-tert-butyl benzene; 3,5-dinitro-2,6-dimethyl-4-tert-butylacetophenone; cinnamonitrile; 3-methyl-5-phenyl-2-pentenenitrile; 3-methyl-5-phenyl pentanenitrile; methyl anthranilate; methyl-N-methylanthranilate; Schiff bases of methyl anthranilate with 7-hydroxy-3,7-dimethyloctanal; 2-methyl-3-(4-tert-butylphenyl)propanal or 2,4-dimethyl-3-cyclohexenecarbaldehyde; 6-isopropylquinoline; 6-isobutylquinoline; 6-secbutylquinoline; 2-(3-phenylpropyl)pyridine; indole; skatole; 2-methoxy-3-isopropylpyrazine; 2-isobutyl-3-methoxypyrazine;
of phenols, phenyl ethers and phenyl esters, such as, for example, estragole; anethole; eugenol; eugenyl, methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;
of heterocyclic compounds, such as, for example, 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;
of lactones, such as, for example, 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin; octahydrocoumarin.

Preferred fragrance substances b) according to the present invention are those, selected from the group of fragrance compounds consisting of 7-hydroxy-3,7-dimethyloctanal; 2,5,7,7-tetramethyloctanal; 4-isopropyl-cyclohexylmethanol; limonene; hexanol; octanol; 3-octanol; 2,6-di methylheptanol; 2-methyl-2-heptanol; 2-methyl-2-octanol; (E)-2-hexenol; (E)- and (Z)-3-hexenol; 3,7-dimethyl-6-octenenitrile; 3,7-dimethyl-octanenitrile; (E)- and (Z)-3-hexenyl formate; (E)- and (Z)-3-hexenyl acetate; octyl acetate; citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; geranial; neral; citronellal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal; menthol; isopulegol; alpha-terpineol; terpinenol-4; menthan-8-ol; menthan-1-01; menthan-7-ol; borneol; isoborneol; linalool oxide; nopol; cedrol; ambrinol; vetiverol; guaiol; and formates, acetates, propionates, isobutyrates, butyrates, isovalerates, pentanoates, hexanoates, crotonates, tiglinates and 3-methyl-2-butenoates thereof; menthone; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; 2-methyl-4-(2,6,6-trimethyl-1-cyclohexen-1-yl)-2-butenal; nootkatone; dihydro-nootkatone; 4,6,8-megastigmatrien-3-one; alpha-sinensal; beta-sinensal; acetylated cedarwood oil (methyl cedryl ketone); 4-tert-butylcyclohexanol; 3,3,5-trimethylcyclohexanol; 3-isocamphylcyclohexanol; alpha-3,3-trimethyl-cyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethyl-cyclohexyl)pentan-3-ol; 1-(2,2,6-trimethylcyclohexyl)hexan-3-ol; 4-tert-butylcyclohexanone; 2,2,5-trimethyl-5-pentylcyclopentanone; 2-heptylcyclopentanone; 2-pentylcyclopentan-one; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; 5-cyclohexadecen-1-one; 6,7-dihydro-1,1,2,3,3-pentamethyl-4(5H)-indanone; 8-cyclohexadecen-1-one; 9-cycloheptadecen-1-one; cyclopentadecanone; cyclohexadecanone; 2,4-dimethyl-3-cyclohexenecarb-aldehyde; 2-methyl-4-(2,2,6-trimethylcyclohexen-1-yl)-2-butenal; 4-(4-hydroxy-4-methylpentyl)-3-cyclohexenecarbaldehyde; 4-(4-methyl-3-penten-1-yl)-3-cyclohexene-carbaldehyde; 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl-2,6,10-trimethyl-2,5,9-cyclododecatrienyl ketone; tert-butyl-(2,4-dimethyl-3-cyclohexen-1-yl)ketone; 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentyl-cyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate; 4,7-methano-3a,4,5,6,7,7a-hexahydro-5 or 6-indenyl isobutyrate; 4,7-methanooctahydro-5 or 6-indenyl acetate; benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzylalcohol; 1-(4-isopropylphenyl)ethanol; benzyl acetate; benzyl propionate; benzyl isobutyrate; benzyl isovalerate; 2-phenylethyl acetate; 2-phenylethyl propionate; benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-isobutylphenyl)propanal; 2-methyl-3-(4-tert-butylphenyl)propanal; 3-(4-tert-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-di methoxybenzaldehyde; 2-methyl-3-(4-methoxyphenyl)propanal; 2-methyl-3-(4-methylenedioxyphenyl)propanal; acetophenone; 4-methylacetophenone; 4-methoxyacetophenone; 4-tert-butyl-2,6-dimethylacetophenone; 4-phenyl-2-butanone; 4-(4-hydroxyphenyl)-2-butanone; 1-(2-naphthalenyl)ethanone; 2-benzofuranyl ethanone; (3-methyl-2-benzofuranyl)ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; estragole; anethole; eugenol; iso-eugenol; thymol; 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin and octahydrocoumarin.

In a preferred embodiment the fragrance compositions of the present invention comprise one or more, usually 1 to 20, preferably 1 to 10, more preferably 1 to 8, more preferably 1 to 6, more preferably 1 to 5, more preferably 1 to 4, even more preferably 1 to 3 and most preferably 1 or 2 additional fragrance substances selected from the group of fragrance listed above, whereas the fragrance substances 7-hydroxy-3,7-dimethyloctanal and 4-isopropyl-cyclohexylmethanol are particularly preferred fragrance substances c) comprised by the fragrance compositions of the present invention.

The fragrance composition of the present invention usually comprises in addition to “high-cis Pyranol” at least one compound with a lily of the valley- or muguet-type fragrance as basic note.

Preferably, the fragrance composition of the present invention comprises as additional fragrance substance b) a compound selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, 2-methyl-3-(4-tert.-butylphenyl)propanal, 3-(4-tert.butylphenyl)propanal, linalool, ethyllinalool, tetrahydrolinalool and 2-methyl-4-phenyl-2-butanol.

The fragrance composition of the present invention comprises usually in addition to “high-cis Pyranol” at least one compound with a floral-type fragrance as basic note, preferably in addition to “high-cis Pyranol” and in addition to at least one compound with a lily of the valley- or muguet-type fragrance as basic note selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, 2-methyl-3-(4-tert.-butylphenyl)propanal, 3-(4-tert.-butylphenyl)propanal, linalool, ethyllinalool, tetrahydrolinalool and 2-methyl-4-phenyl-2-butanol.

In another preferred embodiment the fragrance composition of the present invention comprises as additional fragrance substance b) a compound selected from the group consisting of 2,6-dimethylheptan-2-ol and 3,7-dimethyl-octan-1,7-diol.

Particularly preferred fragrance compositions of the present invention are those comprising 7-hydroxy-3,7-dimethyloctanal (Hydroxycitronellal, CAS Registry Number 107-75-5) of formula (c)

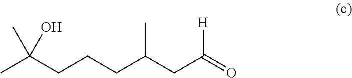

as additional fragrance substance b).

Further particularly preferred fragrance compositions of the present invention are those comprising 4-isopropyl-cyclohexylmethanol (4-(1-methylethyl)-cyclohexanemethanol); CAS Registry Number 13828-37-0) of formula (d)

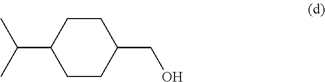

as additional fragrance substance b). The compounds 7-hydroxy-3,7-dimethyloctanal of formula (c) and 4-isopropyl-cyclohexylmethanol of formula (d) are known and commercially widely available e.g. as Mayol® (Firmenich SA), Meijiff™ (International Flavors & Fragrances Inc.) or may be synthesized by known methods.

Further particularly preferred fragrance compositions of the present invention are those comprising 4-(octahydro-4,7-methano-5H-inden-5-yliden)butanal; CAS Registry Number 30168-23-1) of formula (e),

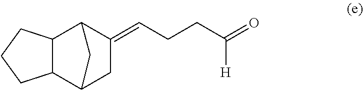 [SMILES: O=CCC/C=C1\CC2CC1C1CCCC21]

as additional fragrance substance b). The compound 4-(Octahydro-4,7-methano-5H-inden-5-yliden)butanal is commercially available as Dupical® (Givaudan).

Further particularly preferred fragrance compositions of the present invention are those comprising the compounds 4-(4-hydroxy-4-methylpentyl)-3-cyclohexen-1-carboxaldehyde of formula (f) and/or 3-(4-hydroxy-4-methylpentyl)-3-cyclohexen-1-carboxaldehyde of formula (g) (CAS Registry Number 31906-04-4 and 51414-25-6 respectively),

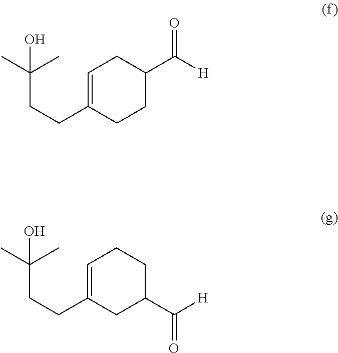

as additional fragrance substance(s) b). The compounds 4-(4-hydroxy-4-methylpentyl)-3-cyclohexen-1-carboxaldehyde and/or 3-(4-hydroxy-4-methylpentyl)-3-cyclohexen-1-carboxaldehyde are commercially available as a 70:30 mixture under tradenames Kovanol® (Takasago) or Lyral® (International Flavors & Fragrances Inc.).

Further particularly preferred fragrance compositions of the present invention are those comprising 2,5,7,7-tetramethyloctanal (CAS Registry Number 114119-97-0) of formula (h)

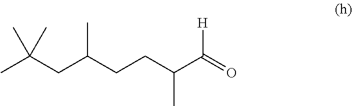

as component b). The compound 2,5,7,7-tetramethyloctanal was or is commercially available as Lyrisal® (BASF) or may be synthesized in pure form, e.g. according to the route as described in EP 0 252 378 by base catalyzed condensation of 3,5,5-trimethylhexanal with propionic aldehyde and subsequent catalytic hydrogenation.

Further particularly preferred fragrance compositions of the present invention are those comprising 2-methyl-3-(4-tert.-butylphenyl)propanal (CAS Registry Number 80-54-6) of formula (a)

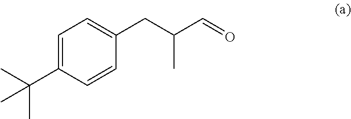

as additional fragrance substance b). The compound 2-methyl-3-(4-tert.-butylphenyl)propanal is commercially available under the tradenames Lysmeral® (BASF SE), Lilial® (Givaudan SA) and Lilestralis® (Innospec Inc.). These products usually also contain the meta-substituted isomer 2-methyl-3-(3-tert.-butylphenyl)propanal (CAS Registry Number 62518-65-4) of formula (b) in an amount of 1 wt. % and higher.

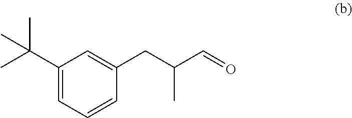

Preferably 2-methyl-3-(4-tert.-butylphenyl)propanal of formula (a) comprises less than 0.3 wt. %, more preferably less than 0.1 wt. % of 2-methyl-3-(3-tert.-butylphenyl)propanal of formula (b) relating to the sum of the compounds of formula (a) and formula (b). 2-methyl-3-(4-tert.-butylphenyl)propanal with less than 0.1 wt % of 2-methyl-3-(3-tert.-butylphenyl)propanal is commercially available under the tradename Lysmeral® Extra (BASF SE).

Further particularly preferred fragrance compositions of the present invention are those comprising 3-(4-tert.-butylphenyl)propanal (CAS Registry Number 18127-01-0) of formula (i)

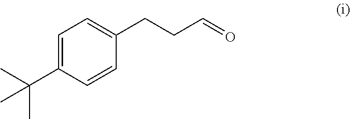

as additional fragrance substance b). The compound 3-(4-tert.-butylphenyl)propanal is also known as Bourgeonal and is commercially available e.g. from O'Laughlin Ind. or Nantong Tiemen Chemical Co., Ltd.

Further particularly preferred fragrance compositions of the present invention are those comprising 2,6-dimethylheptan-2-ol (CAS Registry Number 13254-34-7) of formula (j)

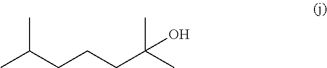

as additional fragrance substance b).

Further particularly preferred fragrance compositions of the present invention are those comprising 3,7-dimethyl-octan-1,7-diol (Hydroxycitronellol; CAS Registry Number 107-74-4) of formula (k)

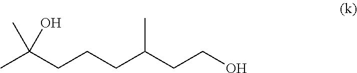

as additional fragrance substance b).

Further particularly preferred fragrance compositions of the present invention are those comprising 2-methyl-4-phenyl-2-butanol (CAS Registry Number 103-05-9) of formula (I),

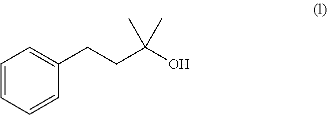

as additional fragrance substance b). The compound 2-methyl-4-phenyl-2-butanol is also known as Carbinol Muguet.

Further particularly preferred fragrance compositions of the present invention are those comprising linalool (CAS Registry Number 78-70-6), tetrahydrolinalool (CAS Registry Number 78-69-3) and ethyllinalool (CAS Registry Number 10339-55-6).

The above mentioned particularly preferred fragrance compositions of the present invention comprising “high-cis Pyranol” and a compound selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, 2-methyl-3-(4-tert.-butylphenyl)propanal, 3-(4-tert.butylphenyl)propanal, linalool, ethyllinalool, tetrahydrolinalool and 2-methyl-4-phenyl-2-butanol comprise preferably as additional fragrance substance b) a compound selected from the group consisting of 2,6-dimethylheptan-2-ol and 3,7-dimethyl-octan-1,7-diol.

A preferred embodiment the fragrance compositions of the present invention comprise the components
a) “high-cis Pyranol” and
b) 7-hydroxy-3,7-dimethyloctanal of formula (c) and one additional fragrance substance selected from the group consisting of 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-4-phenyl-2-butanol, 2-methyl-3-(4-tert.-butylphenyl)propanal, 3-(4-tert.butylphenyl)propanal, 2,6-dimethylheptan-2-ol and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 4-isopropyl-cyclohexylmethanol of formula (d) and one additional fragrance substance selected from the group consisting of 7-hydroxy-3,7-dimethyloctanal, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-4-phenyl-2-butanol, 2-methyl-3-(4-tert.-butylphenyl)propanal, 3-(4-tert.butylphenyl)propanal, 2,6-dimethylheptan-2-ol and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 4-(octahydro-4,7-methano-5H-inden-5-yliden)butanal of formula (e) and one additional fragrance substance selected from the group consisting of 7-hydroxy-3,7-dimethyloctanal, 4-isopropyl-cyclohexylmethanol, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-4-phenyl-2-butanol, 2-methyl-3-(4-tert.-butylphenyl)propanal, 3-(4-tert.butylphenyl)propanal, 2,6-dimethylheptan-2-ol and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 4-(4-hydroxy-4-methylpentyl)-3-cyclohexen-1-carboxaldehyde of formula (f) and/or 3-(4-hydroxy-4-methylpentyl)-3-cyclohexen-1-carboxaldehydede of formula (g) and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 2,5,7,7-tetramethyloctanal, ethyllinalool, linalool, tetrahydrolinalool, 2-methyl-4-phenyl-2-butanol, 2-methyl-3-(4-tert.-butylphenyl)propanal, 3-(4-tert.butylphenyl)propanal, 2,6-dimethylheptan-2-ol and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 2,5,7,7-tetramethyloctanal of formula (h) and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, ethyllinalool, linalool, tetrahydrolinalool, 2-methyl-4-phenyl-2-butanol, 2-methyl-3-(4-tert.-butylphenyl)propanal, 3-(4-tert.-butylphenyl)propanal, 2,6-dimethylheptan-2-ol and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 2-methyl-3-(4-tert.-butylphenyl)propanal of formula (a) and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-4-phenyl-2-butanol, 3-(4-tert.butylphenyl)propanal, 2,6-dimethylheptan-2-ol and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 3-(4-tert.-butylphenyl)propanal of formula (i) and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-4-phenyl-2-butanol, 2-methyl-3-(4-tert.butylphenyl)propanal, 2,6-dimethylheptan-2-ol and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 2,6-dimethylheptan-2-ol of formula (j) and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-4-phenyl-2-butanol, 2-methyl-3-(4-tert.butylphenyl)propanal, 3-(4-tert.-butylphenyl)propanal and 3,7-dimethyloctan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 3,7-dimethyl-octan-1,7-diol of formula (k) and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-4-phenyl-2-butanol, 2-methyl-3-(4-tert.butylphenyl)propanal, 3-(4-tert.-butylphenyl)propanal and 2,6-dimethylheptan-2-ol and optionally one or more additional known fragrance substance(s) and
c) optionally one or more diluent(s).

In another preferred embodiment the fragrance compositions of the present invention comprise the components
a) “high-cis Pyranol” and
b) linalool and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, tetrahydrolinalool, 2-methyl-4-phenyl-2-butanol, 2-methyl-3-(4-tert.-butylphenyl)propanal, 3-(4-tert.butylphenyl)propanal and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) ethyllinalool and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, linalool, tetrahydrolinalool, 2-methyl-4-phenyl-2-butanol, 2-methyl-3-(4-tert.-butylphenyl)propanal, 3-(4-tert.-butylphenyl)propanal and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) tetrahydrolinalool and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, 2-methyl-4-phenyl-2-butanol, 2-methyl-3-(4-tert.-butylphenyl)propanal, 3-(4-tert.-butylphenyl)propanal and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 2-methyl-4-phenyl-2-butanol and one additional fragrance substance selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, ethyllinalool, linalool, tetrahydrolinalool, 2-methyl-3-(4-tert.-butylphenyl)propanal, 3-(4-tert.butylphenyl)propanal and 3,7-dimethyl-octan-1,7-diol and optionally one or more additional known fragrance substance(s) and
c) optionally one or more diluent(s).

In another preferred embodiment the fragrance compositions of the present invention comprise the components
a) “high-cis Pyranol” and
b) 2,5,7,7-tetramethyloctanal of formula (h) and 7-hydroxy-3,7-dimethyloctanal of formula (c) and 4-isopropyl-cyclohexylmethanol of formula (d) and optionally one or more additional fragrance substance(s) and
c) optionally one or more diluent(s).

In yet another even more preferred embodiment the fragrance compositions of the present invention comprise the components
a) “high-cis Pyranol” and
b) 2,5,7,7-tetramethyloctanal of formula (h) and 7-hydroxy-3,7-dimethyloctanal of formula (c) and 3,7-dimethyl-octan-1,7-diol of formula (k) and optionally one or more additional fragrance substance(s) and
c) optionally one or more diluent(s).

In yet another preferred embodiment the fragrance compositions of the present invention comprise the components
a) “high-cis Pyranol” and
b) 2,5,7,7-tetramethyloctanal of formula (h) and 7-hydroxy-3,7-dimethyloctanal of formula (c) and 2,6-dimethylheptan-2-ol of formula (j) and optionally one or more additional fragrance substance(s) and
c) optionally one or more diluent(s).

In yet another even more preferred embodiment the fragrance compositions of the present invention comprise the components
a) “high-cis Pyranol” and
b) 2,5,7,7-tetramethyloctanal of formula (h) and 7-hydroxy-3,7-dimethyloctanal of formula (c) and 2,6-dimethylheptan-2-ol of formula (j) and 3,7-dimethyloctan-1,7-diol of formula (k) and optionally one or more additional fragrance substance(s) and
c) optionally one or more diluent(s).

In yet another even more preferred embodiment the fragrance compositions of the present invention comprise the components
a) “high-cis Pyranol” and
b) 2,5,7,7-tetramethyloctanal of formula (h) and 4-(octahydro-4,7-methano-5H-inden-5-yliden)butanal of formula (e) and 2-methyl-3-(4-tert.butylphenyl)propanal of formula (a) and 2,6-dimethylheptan-2-ol of formula (j) and optionally one or more additional fragrance substance(s) and
c) optionally one or more diluent(s).

In yet another even more preferred embodiment the fragrance compositions of the present invention comprise the components
a) “high-cis Pyranol” and
b) 2,5,7,7-tetramethyloctanal of formula (h) and 7-hydroxy-3,7-dimethyloctanal of formula (c) and 2,6-dimethylheptan-2-ol of formula (j) and 3,7-dimethyloctan-1,7-diol of formula (k) and 4-(octahydro-4,7-methano-5H-inden-5-yliden)butanal of formula (e) and optionally one or more additional fragrance substance(s) and
c) optionally one or more diluent(s).

In yet another even more preferred embodiment the fragrance compositions of the present invention comprise the components
a) “high-cis Pyranol” and
b) 2,5,7,7-tetramethyloctanal of formula (h) and 7-hydroxy-3,7-dimethyloctanal of formula (c) and 2,6-dimethylheptan-2-ol of formula (j) and 3,7-dimethyloctan-1,7-diol of formula (k) and 4-(octahydro-4,7-methano-5H-inden-5-yliden)butanal of formula (e) and 4-(4-hydroxy-4-methylpentyl)-3-cyclohexen-1-carboxaldehyde of formula (f) and/or 3-(4-hydroxy-4-methylpentyl)-3-cyclohexen-1-carboxaldehyde of formula (g) and optionally one or more additional fragrance substance(s) and
c) optionally one or more diluent(s).

In yet an especially preferred embodiment the fragrance compositions of the present invention comprise the components
a) “high-cis Pyranol”
b) 2,5,7,7-tetramethyloctanal of formula (h) and 4-(octahydro-4,7-methano-5H-inden-5-yliden)butanal of formula (e) and 4-(4-hydroxy-4-methylpentyl)-3-cyclohexen-1-carboxaldehyde of formula (f)
c) optionally one or more diluents.

In yet an especially preferred embodiment the fragrance compositions of the present invention comprise the components
a) “high-cis Pyranol”
b) 2-methyl-4-phenyl-2-butanol of formula (i) and 4-(octahydro-4,7-methano-5H-inden-5-yliden)butanal of formula (e) and 4-(4-hydroxy-4-methylpentyl)-3-cyclohexen-1-carboxaldehyde of formula (f)
c) optionally one or more diluents.

In yet an especially preferred embodiment the fragrance compositions of the present invention comprise the components
a) “high-cis Pyranol”
b) 2-methyl-4-phenyl-2-butanol of formula (i) and 4-(octahydro-4,7-methano-5H-inden-5-yliden)butanal of formula (e), 4-(4-hydroxy-4-methylpentyl)-3-cyclohexen-1-carboxaldehyde of formula (f) and one or more compounds selected from the group consisting of linalool, ethyllinalool and tetrahydrolinalool
c) optionally one or more diluents.

For the purposes of the above-mentioned preferred embodiments the term “additional fragrance substance(s)” means one or more, usually 1 to 20, preferably 1 to 10, more preferably 1 to 8, more preferably 1 to 6, more preferably 1 to 5, more preferably 1 to 4, even more preferably 1 to 3 and most preferably 1 or 2 additional fragrance substances selected from the group of known fragrance substances b) listed above other than 7-hydroxy-3,7-dimethyloctanal and 4-isopropyl-cyclohexylmethanol and 4-(octahydro-4,7-methano-5H-inden-5-yliden)butanal and 2,6-dimethylheptan-2-ol and 3,7-dimethyloctan-1,7-diol and 4-(4-Hydroxy-4-methylpentyl)-3-cyclohexen-1-carboxaldehyde and/or 3-(4-Hydroxy-4-methylpentyl)-3-cyclohexen-1-carboxaldehyde.

In the fragrance compositions according to the present invention the weight-based ratio of the total amount of the mixture of diastereomers of 2-isobutyl-4-methyl-tetrahydro-2H-pyran-4-ol of formula I (“high-cis Pyranol”) to the total amount of an additional fragrance substance in the finished fragrance composition may generally be varied within a broad range. Preferably the weight-based ratio of the total amount of “high-cis Pyranol” to the total amount of an additional fragrance substance in the finished fragrance composition ranges from about 50:1 to about 1:50, more preferably from 30:1 to 1:10, more preferably from 20:1 to 1:5, and most preferably from 10:1 to 1:3.

In the preferred fragrance compositions according to the present invention the weight-based ratio of the total amount of the mixture of diastereomers of 2-isobutyl-4-methyl-tetrahydro-2H-pyran-4-ol of formula I (“high-cis Pyranol”) to the total amount of the compound selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, 2-methyl-3-(4-tert.-butylphenyl)propanal, 3-(4-tert.-butylphenyl)propanal, linalool, ethyllinalool, tetrahydrolinalool and 2-methyl-4-phenyl-2-butanol ranges from 50:1 to 1:50, more preferably from 30:1 to 1:10, more preferably from 20:1 to 1:5, and most preferably from 10:1 to 1:3.

In another preferred embodiment of the present invention the weight-based ratio of the total amount of the mixture of diastereomers of 2-isobutyl-4-methyl-tetrahydro-2H-pyran-4-ol of formula I to the total amount of the compound selected from the group consisting of 2,6-dimethylheptan-2-ol and 3,7-dimethyl-octan-1,7-diol in the fragrance composition ranges from 50:1 to 1:50, more preferably from 20:1 to 1:10, more preferably from 20:1 to 1:5, and most preferably from 10:1 to 1:3.

The fragrance compositions according to the present invention comprise at least or ganoleptically active quantities of the mixture of diastereomers of 2-isobutyl-4-methyl-tetrahydro-2H-pyran-4-ol of formula I (“high-cis Pyranol”) and, if present, of the optional further fragrance substances 2,5,7,7-tetramethyloctanal, ethyllinalool, linalool, tetrahydrolinalool, 2-methyl-4-phenyl-2-butanol, 2-methyl-3-(4-tert.-butylphenyl)propanal, 7-hydroxy-3,7-dimethyloctanal and/or 4-isopropyl-cyclohexylmethanol and, if present of the optional further fragrance substances, preferably 2,6-dimethylheptan-2-ol and/or 3,7-dimethyl-octan-1,7-diol. The term “organoleptically active amount” as used herein means an amount sufficient to stimulate an olfactorial impression in a human being, especially the olfactorial impression of a typical lily of the valley- or muguet-type scent.

In the case of the fragrance compositions of the present invention, especially in the case of those comprising “high-cis Pyranol” and 2,5,7,7-tetramethyloctanal and 7-hydroxy-3,7-dimethyloctanal and 4-isopropyl-cyclohexylmethanol generally only minor amounts or concentrations are necessary to generate the desired lily of the valley- or muguet-type fragrance.

In the case of the preferred fragrance compositions of the present invention, especially in the case of those comprising “high-cis Pyranol” and 2,5,7,7-tetramethyloctanal and 7-hydroxy-3,7-dimethyloctanal and 4-isopropyl-cyclohexylmethanol and 4-(octahydro-4,7-methano-5H-inden-5-yliden)butanal and a compound selected from the group consisting of ethyllinalool, linalool and tetrahydrolinalool, and 2-methyl-4-phenyl-2-butanol, 4-(4-hydroxy-4-methylpentyl)-3-cyclohexen-1-carboxaldehyde and/or 3-(4-hydroxy-4-methylpentyl)-3-cyclohexen-1-carboxaldehyde also generally only minor amounts or concentrations are necessary to generate the desired substantive lily of the valley- or muguet-type fragrance.

In the case of the especially preferred fragrance compositions of the present invention, especially in the case of those comprising “high-cis Pyranol” and 2,5,7,7-tetramethyloctanal and 4-(octahydro-4,7-methano-5H-inden-5-yliden)butanal and optionally 4-(4-hydroxy-4-methylpentyl)-3-cyclohexen-1-carboxaldehyde and/or 3-(4-hydroxy-4-methylpentyl)-3-cyclohexen-1-carboxaldehyde also generally only minor amounts or concentrations are necessary to generate the desired substantive lily of the valley- or muguet-type fragrance.

In the case of the especially preferred fragrance compositions of the present invention, especially in the case of those comprising “high-cis Pyranol”, 2-methyl-4-phenyl-2-butanol and 4-(octahydro-4,7-methano-5H-inden-5-yliden)butanal and optionally 4-(4-hydroxy-4-methylpentyl)-3-cyclohexen-1-carboxaldehyde, 3-(4-hydroxy-4-methylpentyl)-3-cyclohexen-1-carboxaldehyde, ethyllinalool, linalool and/or tetrahydrolinalool, also generally only minor amounts or concentrations are necessary to generate the desired substantive lily of the valley- or muguet-type fragrance.

The absolute content of the named ingredients “high-cis Pyranol” and, if present, of the optional further fragrance substances 2,5,7,7-tetramethyloctanal, ethyllinalool, linalool, tetrahydrolinalool, 2-methyl-4-phenyl-2-butanol, 7-hydroxy-3,7-dimethyloctanal and/or 4-isopropyl-cyclohexyl-methanol and, if present of the optional further fragrance substances, preferably 2,6-dimethylheptan-2-ol and/or 3,7-dimethyl-octan-1,7-diol and/or 4-(octahydro-4,7-methano-5H-inden-5-yliden)butanal and 4-(4-hydroxy-4-methylpentyl)-3-cyclohexen-1-carboxaldehyde and/or 3-(4-hydroxy-4-methylpentyl)-3-cyclohexen-1-carboxaldehyde in the fragrance compositions of the present invention, based on the total amount of the fragrance composition, may be varied within broad ranges.

Preferred fragrance compositions of the present invention comprise or consist of, based on the total amount of the finished composition, a total amount of “high-cis Pyranol” in the range from about 0.1 to 95 wt. %, preferably from about 0.1 to 90 wt. %, more preferably from 1 to 90 wt. %, more preferably from 1 to 70 wt. %, more preferably from 5 to 50 wt. %, more preferably from 10 to 50 wt. %, even more preferably from 10 to 40 wt. % and most preferably in the range from 20 to 30 wt. %.

Further more preferred fragrance compositions of the present invention comprise or consist of, based on the total amount of the finished composition, a total amount of “high-cis Pyranol” in the range from about 5 to 80 wt. %, preferably from about 10 to 60 wt. %, more preferably from 15 to 45 wt. %.

Preferred fragrance compositions of the present invention comprise or consist of, based on the total amount of the finished composition, a total amount of 2,5,7,7-tetramethyloctanal in the range from about 0.1 to 95 wt. %, preferably from about 0.1 to 90 wt. %, more preferably from 0.1 to 50 wt. %, more preferably from 0.1 to 40 wt. %, more preferably from 0.1 to 30 wt. %, more preferably from 0.1 to 20 wt. %, more preferably from 0.2 to 15 wt. %, even more preferably from 0.5 to 12 wt. % and most preferably in the range from 1 to 10 wt. %.

Further more preferred fragrance compositions of the present invention comprise or consist of, based on the total amount of the finished composition, a total amount of 2,5,7,7-tetramethyloctanal in the range from about 15 to 90 wt. %, preferably from about 30 to 80 wt. %, more preferably from 50 to 70 wt. %.

Further more preferred fragrance compositions of the present invention comprise or consist of, based on the total amount of the finished composition, a total amount of 2-methyl-4-phenyl-2-butanol, in the range from about 3 to 90 wt. %, preferably from about 5 to 80 wt. %, more preferably from 10 to 70 wt. %.

Further more preferred fragrance compositions of the present invention comprise or consist of, based on the total amount of the finished composition, a total amount of 2-methyl-4-phenyl-2-butanol and linalool and ethylinalool and tetrahydrolinalool, in the range from about 5 to 90 wt. %, preferably from about 10 to 80 wt. %, more preferably from 15 to 70 wt. %.

Those preferred fragrance compositions of the present invention comprising 7-hydroxy-3,7-dimethyloctanal comprise or consist of, based on the total amount of the finished composition, a total amount of 7-hydroxy-3,7-dimethyloctanal in the range of up to 30 wt. %, preferably from 0.1 to 30 wt. %, more preferably from 0.5 to 25 wt. %, more preferably from 1 to 20 wt. %, even more preferably from 1 to 10 wt. % and most preferably in the range from 2 to 7 wt. %.

Small amounts of 4-isopropyl-cyclohexylmethanol, if at all, may be necessary to optimize the desired lily of the valley- or muguet-type scent of the fragrance compositions of the present invention into direction of olfactorial identity with Lysmeral®.

Those preferred fragrance compositions of the present invention comprising 4-isopropyl-cyclohexylmethanol comprise or consist of, based on the total amount of the finished composition, a total amount of 4-isopropyl-cyclohexylmethanol in the range of up to 30 wt. %, preferably from 0.01 to 30 wt. %, more preferably from 0.1 to 20 wt. %, more preferably from 0.1 to 10 wt. %, even more preferably from 0.1 to 5 wt. % and most preferably in the range from 0.1 to 2.5 or even to 1 wt. %.

Small amounts of 4-(octahydro-4,7-methano-5H-inden-5-yliden)butanal, if at all, may be necessary to optimize the desired lily of the valley- or muguet-type scent of the fragrance compositions of the present invention into direction of identity with Lysmeral®.

Those preferred fragrance compositions of the present invention comprising 4-(octahydro-4,7-methano-5H-inden-5-yliden)butanal comprise or consist of, based on the total amount of the finished composition, a total amount of 4-(octahydro-4,7-methano-5H-inden-5-yliden)butanal in the range of up to 30 wt. %, preferably from 0.01 to 30 wt. %, more preferably from 0.1 to 20 wt. %, more preferably from 0.1 to 10 wt. %, even more preferably from 0.1 to 5 wt. % and most preferably in the range from 0.1 to 2.5 or even to 1 wt. %.

Those especially preferred fragrance compositions of the present invention comprising 4-(octahydro-4,7-methano-5H-inden-5-yliden)butanal comprise or consist of, based on the total amount of the finished composition, a total amount of 4-(octahydro-4,7-methano-5H-inden-5-yliden)butanal in the range of up to 5 wt. %, preferably from 0.01 to 3 wt. %, more preferably from 0.1 to 1 wt. %, more preferably from 0.1 to 0.8 wt. %.

Small amounts of 4-(4-hydroxy-4-methylpentyl)-3-cyclohexen-1-carboxaldehyde and/or 3-(4-hydroxy-4-methylpentyl)-3-cyclohexen-1-carboxaldehyde, if at all, may be necessary to optimize the desired lily of the valley- or muguet-type scent of the fragrance compositions of the present invention into direction of identity with Lysmeral®.

Those preferred fragrance compositions of the present invention comprising 4-(4-hydroxy-4-methylpentyl)-3-cyclohexen-1-carboxaldehyde and/or 3-(4-hydroxy-4-methylpentyl)-3-cyclohexen-1-carboxaldehyde comprise or consist of, based on the total amount of the finished composition, a total amount of 4-(4-hydroxy-4-methylpentyl)-3-cyclohexen-1-carboxaldehyde and/or 3-(4-hydroxy-4-methylpentyl)-3-cyclohexen-1-carboxaldehyde in the range of up to 30 wt. %, preferably from 0.01 to 30 wt. %, more preferably from 0.1 to 20 wt. %, more preferably from 0.1 to 15 wt. %, even more preferably from 0.1 to 10 wt. % and most preferably in the range from 0.1 to 5 or even to 1 wt. %.

Those especially preferred fragrance compositions of the present invention comprising 4-(4-hydroxy-4-methylpentyl)-3-cyclohexen-1-carboxaldehyde and/or 3-(4-hydroxy-4-methylpentyl)-3-cyclohexen-1-carboxaldehyde comprise or consist of, based on the total amount of the finished composition, a total amount of 4-(4-hydroxy-4-methylpentyl)-3-cyclohexen-1-carboxaldehyde and/or 3-(4-hydroxy-4-methylpentyl)-3-cyclohexen-1-carboxaldehyde in the range of up to 10 wt. %, preferably from 0.01 to 8 wt. %, more preferably from 0.1 to 5 wt. %, more preferably from 0.1 to 2.5 wt. %.

The perfume compositions of the present invention do preferably not contain significant amounts of 2-methyl-3-(3-tert.-butylphenyl)propanal (the meta-substituted compound of formula (b)). Preferably the weight-based ratio of 2-methyl-3-(4-tert.butylphenyl)propanal to 2-methyl-3-(3-tert.-butylphenyl)propanal, if present at all, in the finished perfume composition ranges from over 10000:1 or higher to 300:1, preferably from 10000:1 to 1000:1.

In a particularly preferred embodiment the fragrance compositions of the present invention comprise, based on the total amount of the finished composition, a total amount of 2-methyl-3-(3-tert.-butylphenyl)propanal of 0.3 wt. % or less, preferably of 0.1 wt. % or less, more preferably of 0.05 wt. % or less and most preferably of 0.01 wt. % or less. In a even more preferred embodiment the fragrance compositions of the present invention are substantially free of 2-methyl-3-(3-tert.-butylphenyl)propanal of formula (b), meaning that it comprises based on the total amount of the finished composition, a total amount of 2-methyl-3-(3-tert.-butylphenyl)propanal of 0.005 wt. % or less, preferably of 0.001 wt. % or less.

The fragrance compositions of the present invention may optionally comprise as component c) one or more diluent(s). The expression “one or more diluent(s)” means that one diluent or a mixture of two or more diluents may be present in fragrance compositions. The term “diluent” means a substance known to those of skill in the art as a suiable solvent for perfume or fragrance compositions such as, e.g. an alcohol such as ethanol or isopropanol and/or a polyol or an ether derived thereof such as diethylene glycol monoethyl ether, glycerol, propylene glycol, 1,2-butylene glycol, dipropylene glycol, diethyl phthalate, triethyl citrate, isopropyl myristate, dialkyl esters of 1,2-cyclohexanedicarboxylic acid, especially 1,2-cyclohexanedicarboxylic acid diisononyl ester (Hexamoll® DINCH, BASF SE) or and the like. Therefore, particularly preferred fragrance compositions according to the present invention comprise one or more diluent(s) c) selected from the group consisting of diethylene glycol monoethyl ether, glycerol, propylene glycol, 1,2-butylene glycol, dipropylene glycol, diethyl phthalate, triethyl citrate, isopropyl myristate and dialkyl esters of 1,2-cyclohexanedicarboxylic acid, especially 1,2-cyclohexanedicarboxylic acid diisononyl ester.

The components of the fragrance compositions according to the present invention, namely “high-cis Pyranol” and, if present, of the optional further fragrance substances 2,5,7,7-tetramethyloctanal, 7-hydroxy-3,7-dimethyloctanal and/or 4-isopropyl-cyclohexylmethanol and, if present other optional further fragrance substances, preferably 2,6-dimethylheptan-2-ol and/or 3,7-dimethyl-octan-1,7-diol and/or 4-(octahydro-4,7-methano-5H-inden-5-yliden)butanal as well as the diluent(s), if present, may be blended or mixed by conventional techniques known to those of skill in the art.

Exemplary fragrance compositions according to the present invention may comprise, based on the total amount of the composition, e.g.:
“high-cis Pyranol”: 10-90 wt. %
2,5,7,7-tetramethyloctanal: 0-90 wt. %
7-hydroxy-3,7-dimethyloctanal: 0-20 wt. %
4-isopropyl-cyclohexylmethanol: 0-1 wt. %
2-methyl-4-phenyl-2-butanol: 0-90 wt. %
linalool: 0-20 wt. %
ethyllinalool: 0-20 wt. %
tetrahydrolinalool: 0-20 wt. %
diluent: ad 100 wt. %
or more preferred:
“high-cis Pyranol”: 9-80 wt. %
2,5,7,7-tetramethyloctanal: 0-70 wt. %
7-hydroxy-3,7-dimethyloctanal: 1-5 wt. %
4-isopropyl-cyclohexylmethanol: 0-1 wt. %
2-methyl-4-phenyl-2-butanol: 0-90 wt. %
linalool: 0-20 wt. %
ethyllinalool: 0-20 wt. %
tetrahydrolinalool: 0-20 wt. %
diluent: ad 100 wt. %
or even more preferred:
“high-cis Pyranol”: 20-80 wt. %
2,5,7,7-tetramethyloctanal: 5-70 wt. %
2-methyl-4-phenyl-2-butanol: 5-50 wt. %
linalool: 0-20 wt. %
ethyllinalool: 0-20 wt. %
tetrahydrolinalool: 0-20 wt. %
7-hydroxy-3,7-dimethyloctanal: 2-7 wt. %
4-isopropyl-cyclohexylmethanol: 0-1 wt. %
diluent: ad 100 wt. %.

Particularly preferred fragrance compositions according to the present invention may comprise, based on the total amount of the composition, e.g.
“high-cis Pyranol”: 10-80 wt. %
2,5,7,7-tetramethyloctanal: 5-70 wt. %
2-methyl-4-phenyl-2-butanol: 9-80 wt. %
linalool: 0-10 wt. %
ethyllinalool: 0-10 wt. %
tetrahydrolinalool: 0-10 wt. %
7-hydroxy-3,7-dimethyloctanal: 1-5 wt. %
2,6-dimethylheptan-2-ol: 0-2 wt. %
3,7-dimethyl-octan-1,7-diol: 1-50 wt. %
4-isopropyl-cyclohexylmethanol: 0-1 wt. %
diluent: ad 100 wt. %
or even more preferred
“high-cis Pyranol”: 20-80 wt. %
2,5,7,7-tetramethyloctanal: 5-50 wt. %
2-methyl-4-phenyl-2-butanol: 5-50 wt. %
linalool: 0-10 wt. %
ethyllinalool: 0-10 wt. %
tetrahydrolinalool: 0-10 wt. %
7-hydroxy-3,7-dimethyloctanal: 1-5 wt. %
2,6-dimethylheptan-2-ol: 0-1 wt. %
3,7-dimethyl-octan-1,7-diol: 5-25 wt. %
4-isopropyl-cyclohexylmethanol: 0-1 wt. %
diluent: ad 100 wt. %
or even more preferred
“high-cis Pyranol”: 20-80 wt. %
2,5,7,7-tetramethyloctanal: 5-20 wt. %
2-methyl-4-phenyl-2-butanol: 5-50 wt. %
linalool: 0-10 wt. %
ethyllinalool: 0-10 wt. %
tetrahydrolinalool: 0-10 wt. %
7-hydroxy-3,7-dimethyloctanal: 2-5 wt. %
2,6-dimethylheptan-2-ol: 0-1 wt. %
3,7-dimethyl-octan-1,7-diol: 5-20 wt. %
4-isopropyl-cyclohexylmethanol: 0-43 wt. %
4-(octahydro-4,7-methano-5H-inden-5-yliden)butanal: 0-5 wt. %
diluent: ad 100 wt. %
or even more preferred
“high-cis Pyranol”: 20-80 wt. %
2,5,7,7-tetramethyloctanal: 5-20 wt. %
2-methyl-4-phenyl-2-butanol: 5-50 wt. %
linalool: 0-10 wt. %
ethyllinalool: 0-10 wt. %
tetrahydrolinalool: 0-10 wt. %
7-hydroxy-3,7-dimethyloctanal: 2-5 wt. %
2,6-dimethylheptan-2-ol: 0-1 wt. %
3,7-dimethyl-octan-1,7-diol: 5-10 wt. %
4-isopropyl-cyclohexylmethanol: 0-1 wt. %
4-(octahydro-4,7-methano-5H-inden-5-yliden)butanal: 0-5 wt. %
diluent: ad 100 wt. %
or even more preferred
“high-cis Pyranol”: 30-80 wt. %
2,5,7,7-tetramethyloctanal: 1-20 wt. %
linalool: 0-10 wt. %
ethyllinalool: 0-10 wt. %
tetrahydrolinalool: 0-10 wt. %
7-hydroxy-3,7-dimethyloctanal: 2-5 wt. %
2,6-dimethylheptan-2-ol: 0-1 wt. %
3,7-dimethyl-octan-1,7-diol: 5-10 wt. %
4-isopropyl-cyclohexylmethanol: 0-1 wt. %
4-(octahydro-4,7-methano-5H-inden-5-yliden)butanal: 0-3 wt. %
4-(4-hydroxy-4-methylpentyl)-3-cyclohexen-1-carboxaldehyde and/or 3-(4-hydroxy-4-methylpentyl)-3-cyclohexen-1-carboxaldehyde: 0-10 wt. %
diluent: ad 100 wt. %
or even more preferred
“high-cis Pyranol”: 30-75 wt. %
2,5,7,7-tetramethyloctanal: 1-20 wt. %
2-methyl-4-phenyl-2-butanol: 5-50 wt. %
linalool: 0-10 wt. %
ethyllinalool: 0-10 wt. %
tetrahydrolinalool: 0-10 wt. %
2-methyl-3-(4-tert.-butylphenyl)propanal: 5-20 wt. %
7-hydroxy-3,7-dimethyloctanal: 2-5 wt. %
2,6-dimethylheptan-2-ol: 0-1 wt. %
3,7-dimethyl-octan-1,7-diol: 0-10 wt. %

4-isopropyl-cyclohexylmethanol: 0-1 wt. %
4-(octahydro-4,7-methano-5H-inden-5-yliden)butanal: 0-5 wt. %
4-(4-hydroxy-4-methylpentyl)-3-cyclohexen-1-carboxaldehyde and/or 3-(4-hydroxy-4-methylpentyl)-3-cyclohexen-1-carboxaldehyde: 0-25 wt. %
diluent: ad 100 wt. %
or even more preferred
“high-cis Pyranol”: 30-75 wt. %

2,5,7,7-tetramethyloctanal: 1-20 wt. %
2-methyl-4-phenyl-2-butanol: 5-50 wt. %
linalool: 0-5 wt. %
ethyllinalool: 0-5 wt. %
tetrahydrolinalool: 0-5 wt. %
4-(octahydro-4,7-methano-5H-inden-5-yliden)butanal: 0-1 wt. %
4-(4-hydroxy-4-methylpentyl)-3-cyclohexen-1-carboxaldehyde and/or 3-(4-hydroxy-4-methylpentyl)-3-cyclohexen-1-carboxaldehyde: 0-20 wt. %
diluent: ad 100 wt. %
or even more preferred
“high-cis Pyranol”: 30-75 wt. %
2,5,7,7-tetramethyloctanal: 0-5 wt. %
2-methyl-4-phenyl-2-butanol: 5-50 wt. %
linalool: 0-5 wt. %
ethyllinalool: 0-5 wt. %
tetrahydrolinalool: 0-5 wt. %
4-(octahydro-4,7-methano-5H-inden-5-yliden)butanal: 0-1 wt. %
4-(4-hydroxy-4-methylpentyl)-3-cyclohexen-1-carboxaldehyde and/or 3-(4-hydroxy-4-methylpentyl)-3-cyclohexen-1-carboxaldehyde: 1-20 wt. %
diluent: ad 100 wt. %
or even more preferred
“high-cis Pyranol”: 30-75 wt. %
2,5,7,7-tetramethyloctanal: 0-5 wt. %
2-methyl-4-phenyl-2-butanol: 5-30 wt. %
linalool: 0-5 wt. %
ethyllinalool: 0-5 wt. %
tetrahydrolinalool: 0-5 wt. %
4-(octahydro-4,7-methano-5H-inden-5-yliden)butanal: 0-1 wt. %
4-(4-hydroxy-4-methylpentyl)-3-cyclohexen-1-carboxaldehyde and/or 3-(4-hydroxy-4-methylpentyl)-3-cyclohexen-1-carboxaldehyde: 1-20 wt. %
diluent: ad 100 wt. %
or even more preferred
“high-cis Pyranol”: 40-75 wt. %
2,5,7,7-tetramethyloctanal: 0-5 wt. %
2-methyl-4-phenyl-2-butanol: 5-25 wt. %
linalool: 0-5 wt. %
ethyllinalool: 0-5 wt. %
tetrahydrolinalool: 0-5 wt. %
4-(octahydro-4,7-methano-5H-inden-5-yliden)butanal: 0-1 wt. %
4-(4-hydroxy-4-methylpentyl)-3-cyclohexen-1-carboxaldehyde and/or 3-(4-hydroxy-4-methylpentyl)-3-cyclohexen-1-carboxaldehyde: 1-20 wt. %
Diluent: ad 100 wt. %

The fragrance compositions of the present invention can also be combined with extracts of natural raw materials such as essential oils, concretes, absolutes, resins, resinoids, balsams, tinctures and the like known to those of skill in the art, comprising but not limited to, for example:

Ambergris tincture; amyris oil; angelica seed oil; angelica root oil; aniseed oil; valerian oil; basil oil; treemoss absolute; bay oil; mugwort oil; benzoin resin; bergamot oil; beeswax absolute; birch tar oil; bitter almond oil; savory oil; buchu leaf oil; cabreuva oil; cade oil; calamus oil; camphor oil; cananga oil; cardamom oil; cascarilla oil; cassia oil; cassie absolute; castoreum absolute; cedar leaf oil; cedarwood oil; cistus oil; citronella oil; citrus oil; copaiba balsam; copaiba balsam oil; coriander oil; costus root oil; cumin oil; cypress oil; davana oil; dill weed oil; dill seed oil; eau de brouts absolute; oakmoss absolute; elemi oil; tarragon oil; eucalyptus citriodora oil; eucalyptus oil; fennel oil; spruce needle oil; galbanum oil; galbanum resin; geranium oil; grapefruit oil; guaiac wood oil; gurjun balsam; gurjun balsam oil; helichrysum absolute; helichrysum oil; ginger oil; iris root absolute; iris root oil; jasmine absolute; calamus oil; camomile blue oil; camomile Roman oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemongrass oil; lovage oil; distilled lime oil; pressed lime oil; linaloe oil; litsea cubeba oil; bayleaf oil; mace oil; marjoram oil; mandarin oil; massoi bark oil; mimosa absolute; musk seed oil; musk tincture; clary sage oil; nutmeg oil; myrrh absolute; myrrh oil; myrtle oil; clove leaf oil; clove flower oil; neroli oil; olibanum absolute; olibanum oil; opopanax oil; orange flower absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil; spike lavender oil; star anise oil; styrax oil; tagetes oil; fir needle oil; tea-tree oil; turpentine oil; thyme oil; tolu balsam; tonka absolute; tuberose absolute; vanilla extract; violet leaf absolute; verbena oil; vetiver oil; juniper beny oil; cognac oil; wormwood oil; wintergreen oil; ylang-ylang oil; hyssop oil; civet absolute; cinnamon leaf oil; cinnamon bark oil and fractions thereof, or ingredients isolated therefrom.

The fragrance compositions of the present invention can also be combined with anti-oxidants (stabilizers) known to those of skill in the art, comprising but not limited to, for example:

phenolic antioxidants such as sodium salicylate, 2,4-dihydroxybenzophenone, 2,6-di-t-butyl-p-cresol, butylated hydroxyanisole (BHA), 2,6-di-t-butyl-4-methylphenol (BHT), 2,6-di-t-butyl-4-ethylphenol, stearyl-3-(3,5-di-t-butyl-4-hydroxyphenyl)propionate, propyl 3,4,5-trihydroxybenzoate, hydroquinone, and catechol;
bisphenolic antioxidants such as 2,2′-methylenebis(4-methyl-6-t-butylphenol), 2,2′-methylenebis(4-ethyl-6-t-butylphenol), 4,4′-thiobis(3-methyl-6-t-butylphenol), 4,4′-butylidenebis(3-methyl-6-t-butylphenol) 3,9-bis[1,1-dimethyl-2-[β-(3-t-butyl-4-hydroxy-5-methylphenyl)propionyloxy]ethyl]2,4,8,10-tetraoxaspiro[5,5]undecane, and 4,4′-(2,3-dimethyltetramethylene)dipyrrocatechol;
high-molecular phenolic antioxidants such as 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis-(4′-hydroxy-3′-t-butylphenyl)butyric acid]glycol ester, 1,3,5-tris(3′,5′-di-t-butyl-4′-hydroxybenzyl)-s-triazine-2,4,6-(1H,3H,5H)trione, and alpha-tocopherol; tocotrienols and their esters;
alcoholic antioxidants such as erythorbic acid, sodium erythorbat and isopropyl citrate; as well as ascorbic acid and its esters, especially ascorbyl palmitate;
and other anti-oxidants such as N-aspartylphenylalanin alkyl ester, eugenol oisoeugenol, quercetin-7,4-dimethoxy-5-hydroxy-flavone, gallic acid, chlorogenic acid, dihydro-norguajaretic acid (NDGA), caffeic acid.

Further, the fragrance compositions of the present invention may contain the usual amounts of fixatives known to those of skill in the art. Preferred fixative for the use in the fragrance compositions of the present invention include but are not limited to sandalwood, ambra products, polycyclic, macrocyclic and alicyclic substances like Ambrox® (Firmenich SA), Galaxolide® (Int. Flavors & Fragrances Inc.), Tonalide, Exaltolide® (Firmenich SA), Habanolide® (Firmenich SA) and Helvetolide® (Firmenich SA).

The fragrance compositions of the present invention can also comprise encapsulating substances like cyclodextrines; chelating and complexing agents like EDTA or citric acid.

The fragrance compositions of the present invention may advantageously used for emparting and/or enhancing an odor or flavor of a product or article of all kind with a lily of the valley- or muguet-type note or with a syringa-type note, a magnolia-type note, a cyclamen-type note or a hyacinth-type note, preferably with a lily of the valley- or muguet-type note. A further embodiment of the present invention therefore relates to a method for emparting and/or enhancing an odor or flavor of a product or article with a lily of the valley- or muguet-type note or with a syringa-type note, a magnolia-type note, a cyclamen-type note, a hyacinth-type note or a lilac-type note, preferably with a lily of the valley- or muguet-type note, comprising bringing into contact or mixing with or adding to said product or article an organoleptically active quantity of a fragrance composition according to the present invention whereas the term “organoleptically active quantity” has the meaning as defined above. The fragrance compositions of the present invention may be used or applied in every suited form e.g. in pure form or in form of dilutions or mixtures as well as in microencapsulated form.

Therefore, a further embodiment of the present invention relates to a method for producing a perfumed product or article comprising bringing into contact or mixing with or adding to said product or article an organoleptically active quantity of the fragrance composition according to the present invention.

In yet a further embodiment the present invention relates to a perfumed or aromatized product or article comprising an organoleptically active quantity of the fragrance composition according to the present invention as hereinbefore described. The perfumed or aromatized articles or products accessible by the present invention may be a perfumed or aromatized article of manufacture of all kind. Preferred aromatized or perfumed articles or products comprise, but are not limited to, e.g. perfumes, detergents and washing soaps, both liquid and solid and toilet articles of all kinds. Preferred perfumed or aromatized articles according to the present invention are selected from the group consisting of extracts, eaux de partum, eaux de toilette, after-shave lotions, eaux de Cologne, pre-shave products, splash colognes, perfumed refreshing tissues, acidic, alkaline and neutral cleaning products, textile fresheners, ironing aids, liquid detergents, powder detergents, fabric preconditioners, fabric softeners, washing soaps, washing tablets, disinfectants, surface disinfectants, air purifiers, aerosol sprays, waxes and polishes, body care products, hand creams and lotions, foot creams and lotions, depilatory creams and lotions, after-shave creams and lotions, tanning creams and lotions, treatment cosmetic products, hair care products, deodorants and antiperspirants, decorative cosmetic products, candles, lamp oils, incense sticks, insecticides, repellents and propellants.

The following examples illustrate the present invention without, however, limiting it in any way:

### EXAMPLE 1

### Preparation of Pyranol with 94% of the Cis-Racemate by Distillation

Pyranol with 94% of the cis-racemate was obtained as side product stream during the distillation of Pyranol 40/60 (40% trans-Pyranol, 60% cis-Pyranol) starting from a mixtures of diastereomers of 2-isobutyl-4-methyl-tetrahydro-2H-pyran-4-ol of formula I comprising 82 wt. % of cis-racemate and 17.5 wt. % of the trans-racemate. This mixture was obtained according to the method described in the international application PCT/EP2010/056403. A dividing wall column was used. The column was constructed from 3 jacketed, internally mirrored and evacuated glass sections with an internal diameter of 43 mm. Column sections 2 (counted from the bottom) with a total length of 105 cm was provided with a firmly welded-in dividing wall made of glass about 1 mm in thickness.

In the region of the dividing wall, the column is equipped with a Montz A3 1000-packing. The length of the packing is 1 m on the feed side and 0.9 m on the discharge side. Above and below the dividing wall section the column has a glass section of 50 cm in length, each being equipped with 33 cm of Sulzer DX-packings. The separation efficiency in the dividing wall region was ca. 32 theoretical plates. The total number of theoretical plates including the dividing wall region was ca. 50.

The column was heated using an oil-heated laboratory rotary thin-film evaporator. At the top of the column, the vapors were condensed using a thermostat-cooled glass condenser.

Temperatures at different levels in the column and the top pressure and the pressure drop over the column were measured by means of a measurement recording system.

The column had flow meters in the feed stream, in the discharge streams and the reflux stream. The reflux flow was used to regulate the oil temperature in the evaporator heating system. This control system ensured a constant return rate, which also established a constant pressure difference. The partitioning of the liquid stream above the divided wall on the feed and discharge side was realized by a clock pulsed pivoting hopper.

The feed stream was added at the height of the middle of the dividing wall section. The feed flow rate was 100 g/h. The feed stream contained

17.5 weight-% trans-Pyranol
82.0 weight-% cis-Pyranol

The column was operated at a top pressure of 10 mbar and a reflux mass flow of 460 g/h. A pressure drop of 2 mbar was established.

At the top of the column, a temperature of 100° C. was measured, and in the bottom a temperature of 105° C. was measured.

By means of a balance control system, the bottom take-off was fixed at 67 g/h and the distillate withdrawal at 2.5 g/h. The reflux ratio was thus about 180:1.

The liquid was divided above the dividing wall in a ratio of 1:2 (feed section: withdrawal section). At the side of the dividing wall opposite the feed side, at the same height as the feed stream, a liquid side take-off was removed. The flow rate was fixed at 30.5 g/h.

The product stream (side take-off) comprised

39.3 weight-% trans-Pyranol
60.6 weight-% cis-Pyranol

The top stream drawn off at the top of the column comprised:

0.58 weight-% Dihydropyran-Isomeres
0.42 weight-% 1,3 Dioxan
87.7 weight-% trans-Pyranol
11.2 weight-% cis-Pyranol

The stream drawn off at the bottom of the column comprised:

5.4 weight-% trans-Pyranol
94.3 weight-% cis-Pyranol

### EXAMPLE 2

### Preparation of Pyranol with 98% of the Cis-Racemate by Distillation

Pyranol with 98% of the cis-racemate can be obtained as bottom stream by the distillation of the stream drawn off side product of Experiment 1).

For the production of Pyranol 2/98 (2% trans-Pyranol, 98% cis-Pyranol) a laboratory column might be used. The inside diameter is typically 43 mm. The column is assembled of two double wall, inside glass reflected and evacuated glass sections with a total length of 1440 mm. The column is equipped with a Montz A3 1000-packing. The length of the packing is approximately 1.4 m. The separating capacity of the column corresponds to approximately 30 theoretical plates.

The feed stream is added in the middle of the column. The column can be heated using an oil-heated laboratory thin film evaporator. The vapors on top of the column are condensed by a laboratory glass condenser.

The temperature along the column is measured. The pressure on top of the column and the pressure drop along the column packings are measured as well.

The column has flow meters in the feed stream, in the discharge streams and the reflux stream. The reflux flow is used to regulate the oil temperature in the evaporator heating system. In this way the reflux stream and consequently the pressure drop of the column are kept constant. The mass flow of the feed stream is 100 g/h.

The feed stream contains

5.4 weight-% trans-Pyranol
94.3 weight-% cis-Pyranol

The feed stream might be the bottom stream respectively the waste stream of a distillation process producing Pyranol 40/60 (40% trans-Pyranol, 60% cis-Pyranol) as a top stream.

The column is operated at a top pressure of 10 mbar and a reflux mass flow of 245 g/h. A pressure drop of 2 mbar is observed.

The temperature on the top of the column is set to about 102° C.; the temperature on the bottoms is set to about 122° C. The bottom stream is regulated by scale on a constant flow rate of 90 g/h. In the same way the top stream is regulated to 10 g/h. The reflux ratio is calculated to 25.

The top stream contains

40 weight-% trans-Pyranol
60 weight-% cis-Pyranol

The bottom stream contains

2 weight-% trans-Pyranol
98 weight-% cis-Pyranol

### COMPARATIVE EXAMPLE 3 AND EXAMPLE 3a AND 3b

| Component | Example 3 | Example 3a | Example 3b |
|---|---|---|---|
| 2,5,7,7-tetramethyoctanal | 15% | 15% | 5% |
| 7-hydroxy-3,7- | 5% | 5% | 5% |
| dimethyloctanal | | | |
| Pyranol with 80% cis | 75% | 0% | 0% |
| Pyranol with 97% cis | 0% | 75% | 75% |
| 4-isopropyl- | 0% | 0% | 0% |
| cyclohexylmethanol | | | |
| 2,6-dimethylheptan-2-ol | 0% | 0% | 0% |
| 3,7-dimethyl-octan-1,7-diol | 0% | 0% | 0% |
| 4(3)-(4-hydroxy-4-methyl- | 5% | 5% | 5% |
| pentyl)-3-cyclohexen-1- | | | |
| carboxaldehyde | | | |
| 4-(octahydro-4,7-methano- | 0% | 0% | 0% |
| 5H-inden-5-yliden)butanal | | | |
| 2-methyl-4-phenyl-2-butanol | 0% | 0% | 10% |
| Sum ingredients | 100% | 100% | 100% |
| Solvent: dipropylenglcol | 0% | 0% | 0% |
| Sum | 100% | 100% | 100% |
| Olfactory description: | floral, | Well-balanced, | Well-balanced, |
| | fresh, | impactful floral, | impactful floral, |
| | light, | fresh, light, | fresh, light, |
| | slightly | slightly fruity, | aldehydic note |
| | fruity, | aldehydic note | with a muguet |
| | aldehy- | as a possible | impression as |
| | dic | alternative to | a possible |
| | | Lysmeral ® | alternative to |
| | | Extra | Lysmeral ® |
| | | | Extra |
| Specific application: | for all | for all | for all |
| | purposes | purposes | purposes |

### COMPARATIVE EXAMPLE 4 AND EXAMPLES 4a TO 4d

| Component | Ex. 4 | Ex. 4a | Ex. 4b | Ex. 4c | Ex. 4d |
|---|---|---|---|---|---|
| 2,5,7,7- | 35% | 35% | 25% | 20% | 10% |
| tetramethyoctanal | | | | | |
| 7-hydroxy-3,7- | 0% | 0% | 4% | 4% | 5% |
| dimethyloctanal | | | | | |
| Pyranol with 80% | 60% | 0% | 0% | 0% | 0% |
| cis | | | | | |
| Pyranol with 97% | 0% | 60% | 50% | 45% | 45% |
| cis | | | | | |
| 4-isopropyl- | | | | | |
| cyclohexylmetha- | 0% | 0% | 0% | 0% | 0% |
| nol | | | | | |
| 2,6- | | | | | |
| dimethylheptan-2- | 0% | 0% | 0% | 0% | 0% |
| ol | | | | | |
| 3,7-dimethyl- | 0% | 0% | 0% | 0% | 10% |
| octan-1,7-diol | | | | | |
| 4(3)-(4-hydroxy-4- | | | | | |
| methylpenty1)-3- | 5% | 5% | 5% | 5% | 3% |
| cyclohexen-1- | | | | | |
| carboxaldehyde | | | | | |
| 4-(octahydro-4,7- | 0% | 0% | 1% | 1% | 1% |
| methano-5H- | | | | | |
| inden-5- | | | | | |
| yliden)butanal | | | | | |
| Sum ingredients | 100% | 100% | 85% | 75% | 74% |
| Solvent: dipropy- | 0% | 0% | 15% | 25% | 26% |
| lenglcol | | | | | |
| Sum | 100% | 100% | 100% | 100% | 100% |
| Olfactory | Good | Strong | Similar to | Similar | Similar |
| description: | floral | floral im- | 4a, but | to | to 4a, |
| | impact, | pact, | more im- | 4a, but | but |
| | fresh, | fresh, | pact and | more im- | strong- |
| | slightly | green, | more fac- | pact and | er |
| | fruity, al- | aldehydic | ets of | more fac- | impact |
| | dehydic | and more | muguet, | ets of | |
| | | powerful | | muguet | |
| | | than ex. 4 | | | |
| Specific applica- | for all pur- | for all pur- | for all pur- | for all pur- | for all |
| tion: | poses, in | poses, in | poses, in | poses, in | pur- |
| | particular | particular | particular | particular | poses |
| | for deter- | for deter- | for deter- | for deter- | |
| | gents | gents | gents | gents | |

### COMPARATIVE EXAMPLE 5 AND EXAMPLES 5a TO 5c

| Component | Ex. 5 | Ex. 5a | Ex. 5b | Ex. 5c |
|---|---|---|---|---|
| 2,5,7,7-tetramethyoctanal | 69% | 50% | 50% | 50% |
| 7-hydroxy-3,7-dimethyloctanal | 1% | 1% | 1% | 0% |
| Pyranol with 80% cis | 30% | 0% | 0% | 0% |
| Pyranol with 97% cis | 0% | 30% | 30% | 30% |
| 4-isopropyl-cyclohexylmethanol | 0% | 0% | 0% | 0% |
| 2,6-dimethylheptan-2-ol | 0% | 0% | 0% | 1% |
| 3,7-dimethyl-octan-1,7-diol | 0% | 0% | 0% | 5% |
| 4(3)-(4-hydroxy-4-methylpentyl)- | 0% | 0% | 1% | 1% |
| 3-cyclohexen-1-carboxaldehyde | | | | |
| 4-(octahydro-4,7-methano-5H- | 0% | 0% | 1% | 1% |
| inden-5-yliden)butanal | | | | |
| Sum ingredients | 100% | 81% | 83% | 88% |
| Solvent: dipropylenglcol | 0% | 19% | 17% | 12% |
| Sum | 100% | 100% | 100% | 100% |
| Olfactory description: | regular | higher | more | more |
| all samples are fresh floral, | impact | impact, | power | power |
| slightly fruity, aldehydic but | | better | and | and |
| show the following difference | | balance | impact, | impact, |
| | | | longer | longer |
| | | | lasting- | lasting- |
| | | | ness | ness |
| Specific application: | for all | for all | for all | for all |
| | pur- | pur- | pur- | pur- |
| | poses | poses | poses | poses |

### COMPARATIVE EXAMPLES 6 AND 7 AND EXAMPLES 6a AND 7a

| Component | Ex. 6 | Ex. 6a | Ex. 7 | Ex. 7a |
|---|---|---|---|---|
| 2,5,7,7-tetramethyoctanal | 5% | 5% | 0% | 0% |
| 7-hydroxy-3,7- | 4% | 4% | 0% | 0% |
| dimethyloctanal | | | | |
| Pyranol with 80% cis | 90% | 0% | 50% | 0% |
| Pyranol with 97% cis | 0% | 90% | 0% | 50% |
| 4-isopropyl- | 0% | 0% | 0% | 0% |
| cyclohexylmethanol | | | | |
| 2,6-dimethylheptan-2-ol | 0% | 0% | 0% | 0% |
| 3,7-dimethyl-octan-1,7-diol | 0% | 0% | 0% | 0% |
| 4(3)-(4-hydroxy-4- | 0% | 0% | 0% | 0% |
| methylpentyl)-3- | | | | |
| cyclohexen-1-carboxaldehyde | | | | |
| 2-methyl-4-phenyl-2-butanol | 0% | 0% | 50% | 50% |
| 4-(octahydro-4,7-methano- | 1% | 1% | 0% | 0% |
| 5H-inden-5-yliden)butanal | | | | |
| Sum ingredients | 100% | 100% | 100% | 100% |
| Solvent: dipropylenglcol | 0% | 0% | 0% | 0% |
| Sum | 100% | 100% | 100% | 100% |
| Olfactory description: | Fresh, | more ra- | Muguet | Powerful, |
| | floral, | diation | base with | clean, |
| | slightly | and im- | regular | clear |
| | fruity, | pact than | impact | muguet |
| | al- | 6 | | base with |
| | de- | | | good lily- |
| | hydic | | | of-the- |
| | | | | valley |
| | | | | impact |
| Specific application: | for all | for all | for all | for all |
| | pur- | pur- | pur- | pur- |
| | poses, | poses, in | poses | poses |
| | in par- | particular | | |
| | ticular | for | | |
| | for | fine | | |
| | fine | fra- | | |
| | fra- | grances | | |
| | grances | | | |

### EXAMPLES 8 TO 10

| Component | Example 8 | Example 9 | Example 10 |
|---|---|---|---|
| 2-methyl-4-phenyl- | 12.5% | 16% | 10% |
| 2-butanol | | | |
| 7-hydroxy-3,7- | 25% | 0% | 5% |
| dimethyloctanal | | | |
| Pyranol with 80% cis | 0% | 0% | 0% |
| Pyranol with 97% cis | 44% | 75% | 75% |
| ethyllinalool | 3% | 0% | 4% |
| 2,6-dimethylheptan- | 0% | 0% | 0% |
| 2-ol | | | |
| 3,7-dimethyl-octan-1, | 0% | 0% | 0% |
| 7-diol | | | |
| 4(3)-(4-hydroxy-4- | 15% | 8.8% | 5% |
| methyl-pentyl)-3- | | | |
| cyclohexen-1- | | | |
| carboxaldehyde | | | |
| 4-(octahydro-4,7- | 0.5% | 0.2% | 1% |
| methano-5H-inden-5- | | | |
| yliden)butanal | | | |
| Sum ingredients | 100% | 100% | 100% |
| Solvent: | 0% | 0% | 0% |
| dipropylenglcol | | | |
| Sum | 100% | 100% | 100% |
| Olfactory | Attractive, har- | Powerful and | Powerful and |
| description: | monising and | attractive har- | atractive harmo- |
| | floralising | monising and | nising and floral- |
| | muguet base, | floralising | ising muguet |
| | an alterna- | muguet base, | base, covering |
| | tive to | covering many | many floral fac- |
| | Lysmeral ® | floral facets, an | ets, an alterna- |
| | Extra | alternative to | tive to Lys- |
| | | Lysmeral ® | meral ® Extra |
| | | Extra | |
| Specific application: | for all purposes | for all purposes | for all purposes |

### EXAMPLES 10 TO 12

| Component | Example 11 | Example 12 |
|---|---|---|
| 2-methyl-4-phenyl-2-butanol | 20% | 19.5% |
| 7-hydroxy-3,7- | 5% | 3% |
| dimethyloctanal | | |
| Pyranol with 80% cis | 0% | 0% |
| Pyranol with 97% cis | 50% | 70% |
| ethyllinalool | 3% | 1% |
| 2,6-dimethylheptan-2-ol | 0% | 1% |
| 3,7-dimethyl-octan-1,7-diol | 10% | 2% |
| 4(3)-(4-hydroxy-4-methyl- | 5% | 3% |
| pentyl)-3-cyclohexen-1- | | |
| carboxaldehyde | | |
| 4-(octahydro-4,7-methano- | 1% | 0.5% |
| 5H-inden-5-yliden)butanal | | |
| Sum ingredients | 94% | 100% |
| Solvent: dipropylenglcol | 6% | 0% |
| Sum | 100% | 100% |
| Olfactory description: | Powerful and attrac- | Powerful and attrac- |
| | tive harmonising and | tive harmonising |
| | floralising muguet | and floralising |
| | base, covering many | muguet base, cov- |
| | floral facets, an | ering many floral |
| | alternative to | facets, an alterna- |
| | Lysmeral ® | tive to Lysmeral ® |
| | Extra | Extra |
| Specific application: | for all purposes | for all purposes |

### COMPARATIVE EXAMPLE 13 AND EXAMPLES 13a TO 13c

| Component | Ex. 13 | Ex. 13a | Ex. 13b | Ex. 13c |
|---|---|---|---|---|
| 2,5,7,7- | 0% | 0% | 0% | 0% |
| tetramethyoctanal | | | | |
| 7-hydroxy-3,7- | 0% | 0% | 0% | 4% |
| dimethyloctanal | | | | |
| Pyranol with 80% cis | 0% | 0% | 0% | 0% |
| Pyranol with 97% cis | 0% | 30% | 50% | 40% |
| 2,6-dimethylheptan-2-ol | 0% | 0% | 0% | 1% |
| 3,7-dimethyl-octan- | 0% | 0% | 0% | 5% |
| 1,7-diol | | | | |
| 2-methyl-3-(4-tert.- | 100% | 70% | 50% | 50% |
| butylphenyl)propanal | | | | |
| 4-(octahydro-4,7- | 0% | 0% | 0% | 0% |
| methano-5H-inden-5- | | | | |
| yliden)butanal | | | | |
| Sum ingredients | 100% | 100% | 100% | 100% |
| Solvent: | 0% | 0% | 0% | 0% |
| dipropylenglcol | | | | |
| Sum | 100% | 100% | 100% | 100% |
| Olfactory description: | Lys- | Improved | Improved | Improved |
| | meral ® | rounding | rounding | rounding |
| | Extra | up of pure | up of pure | up of pure |
| | | Lys- | Lys- | Lys- |
| | | meral ® | meral ® | meral ® |
| | | Extra | Extra | Extra |
| Specific application: | for all pur- | for all pur- | for all pur- | for all pur- |
| | poses | poses | poses | poses |

1.-13. (canceled)

14. A fragrance composition comprising
a) a mixture of diastereomers of 2-isobutyl-4-methyl-tetrahydro-2H-pyran-4-ol of formula I 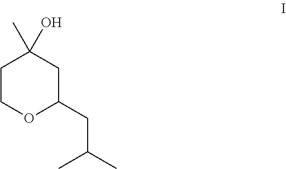
wherein the mixture of diastereomers comprises more than 95 wt. % of the optically inactive cis-racemate of the formulae cis-I(+) and cis-I(−) 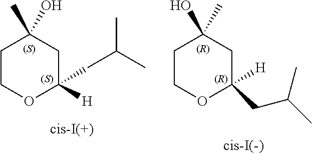
and less than 5 wt. % of the optically inactive trans-racemate of the formulae trans-I(+) and trans-I(−), 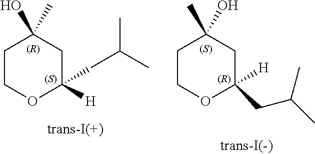
b) optionally one or more additional fragrance substance(s) and
c) optionally one or more diluent(s).

15. A fragrance composition according to claim 14, wherein the mixture of diastereomers of 2-isobutyl-4-methyl-tetrahydro-2H-pyran-4-ol of formula I comprises from 95.5 to 99.5 wt. % of the optically inactive cis-racemate of the formulae cis-I(+) and cis-I(−) and
from 0.5 to 4.5 wt. % of the optically inactive trans-racemate of the formulae trans-I(+) and trans-I(−).

16. A fragrance composition according to claim 14, comprising as additional fragrance substance b) a compound selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, 2-methyl-3-(4-tert.-butylphenyl)propanal, 3-(4-teabutylphenyl)propanal, linalool, ethyllinalool, tetrahydrolinalool and 2-methyl-4-phenyl-2-butanol.

17. A fragrance composition according to claim 14, comprising as additional fragrance substance b) a compound selected from the group consisting of 2,6-dimethylheptan-2-ol and 3,7-dimethyl-octan-1,7-diol.

18. A fragrance composition according to claim 14, wherein the fragrance composition comprises, based on the total amount of the composition, a total amount of the mixture of diastereomers of 2-isobutyl-4-methyl-tetrahydro-2H-pyran-4-ol of formula I in the range from 0.1 to 98 wt. %.

19. A fragrance composition according to claim 16, wherein the weight-based ratio of the total amount of the mixture of diastereomers of 2-isobutyl-4-methyl-tetrahydro-2H-pyran-4-ol of formula I to the total amount of the compound selected from the group consisting of 7-hydroxy-3,7-dimethyloctanal, 4-isopropyl-cyclohexylmethanol, 4-(octahydro-4,7-methano-5H-inden-5-yliden)butanal, 4-(4-hydroxy-4-methylpentyl)-3-cyclohexen-1-carboxaldehyde and/or 3-(4-hydroxy-4-methylpentyl)-3-cyclohexen-1-carboxaldehyde, 2,5,7,7-tetramethyloctanal, 2-methyl-3-(4-tert.-butylphenyl)propanal, 3-(4-tert.-butylphenyl)propanal, linalool, ethyllinalool, tetrahydrolinalool and 2-methyl-4-phenyl-2-butanol in the fragrance composition ranges from 50:1 to 1:50.

20. A fragrance composition according to claim 17, wherein the weight-based ratio of the total amount of the mixture of diastereomers of 2-isobutyl-4-methyl-tetrahydro-2H-pyran-4-ol of formula I to the total amount of the compound selected from the group consisting of 2,6-dimethylheptan-2-ol and 3,7-dimethyl-octan-1,7-diol in the fragrance composition ranges from 50:1 to 1:50.

21. A fragrance composition according to claim 14, wherein the fragrance composition comprises, based on the total amount of the composition, a total amount of 2-methyl-3-(3-tert.-butylphenyl)propanal of 0.1 wt. % or less.

22. A fragrance composition according to claim 14, wherein the fragrance composition comprises one or more diluent or diluents selected from the group consisting of diethylene glycol monoethyl ether, glycerol, propylene glycol, 1,2-butylene glycol, dipropylene glycol, diethyl phthalate, triethyl citrate, isopropyl myristate and dialkyl esters of 1,2-cyclohexanedicarboxylic acid, especially 1,2-cyclohexanedicarboxylic acid diisononyl ester.

23. A method for imparting and/or enhancing an odour or flavour of a product or article with a lily of the valley- or muguet-type note, a syringa-type note, a magnolia-type note, a cyclamen-type note, a hyacinth-type note or a lilac-type note comprising bringing into contact or mixing with or adding to said product or article an organoleptically active quantity of a fragrance composition according to claim 14.

24. A method for producing a perfumed product or article comprising bringing into contact or mixing with or adding to said product or article an organoleptically active quantity of the fragrance composition according to claim 14.

25. A perfumed or aromatized product or article comprising an organoleptically active quantity of the fragrance composition according to claim 14.

26. A perfumed article or product according to claim 25, wherein the article or product is selected from the group consisting of perfume extracts, eaux de parfum, eaux de toilette, after-shave lotions, eaux de Cologne, pre-shave products, splash colognes, perfumed refreshing tissues, acidic, alkaline and neutral cleaning products, textile fresheners, ironing aids, liquid detergents, powder detergents, fabric preconditioners, fabric softeners, washing soaps, washing tablets, disinfectants, surface disinfectants, air purifiers, aerosol sprays, waxes and polishes, body care products, hand creams and lotions, foot creams and lotions, depilatory creams and lotions, treatment cosmetic products, after-shave creams and lotions, tanning creams and lotions, hair care products, deodorants and antiperspirants, decorative cosmetic products, candles, lamp oils, incense sticks, insecticides, repellents and propellants.
